(19) United States
(12) Patent Application Publication
(10) Pub. No.: US 2012/0170989 A1
(43) Pub. Date: Jul. 5, 2012

(54) HAND-HELD WATER DRILL

(76) Inventor: Jeff Hardin, Chaska, MN (US)

(21) Appl. No.: 13/174,561

(22) Filed: Jun. 30, 2011

Related U.S. Application Data
(60) Provisional application No. 61/360,909, filed on Jul. 1, 2010.

(51) Int. Cl. B23B 51/06; B23B 41/00; B23B 45/00

(52) U.S. Cl. 408/56; 222/191; 408/226

(57) ABSTRACT

A hand-held water drill system including a drill coupled to a shank to transmit torque to a drill bit. A solution delivery device substantially surrounding the shank provides solution to the drill bit. The shank freely rotates within the solution delivery device. The solution delivery device includes a handle having a channel. A solution delivery control is provided to operate the valve to allow flow control of the solution to the drill bit distal end while allowing the user to maintain a grip on the handle. Additionally, the solution delivery device is positioned and constructed to provide improved control of the position of the drill bit during use.

### BACKGROUND

1. Field of Art

This disclosure relates generally to the field of drilling systems. More specifically, this disclosure relates to a hand-held water drilling system allowing drilling through hard surfaces such as glass, marble, tile, granite or porcelain.

2. Description of the Related Art

Because of the hardness of many surfaces, such as porcelain, glass, marble or granite, drilling holes through these surfaces generally requires specialized techniques. In particular, when drilling through a surface such as porcelain, glass or marble, the tip of the drill bit used needs to be frequently lubricated for cooling as well as to prevent excessive wear or breakage. Conventional drilling techniques direct a stream of water over the drill bit during operation using a hose; however, these methods frequently require two people for drilling, a first person drilling and a second person directing water over the drill bit. Frequently, these conventional techniques apply water to the surface of the tile being drilled to cool the drill bit tip. If a single person is drilling through tile, or similar hard surface, drilling time increases as the single person must periodically stop drilling and spray water, or other lubricant, onto the tip of the drill bit.

Additionally, when starting to drill through a hard surface, such as glass, porcelain, marble or granite, a drill bit generally moves across the surface rather than biting into the tile and beginning to bore. This frequently results in multiple scratches across the surface. Lubricating the surface using water, or another lubricant, decreases the likelihood of the drill bit moving across the surface.

### SUMMARY

The disclosed embodiments and principles provide a hand-held water drilling system simplifying delivery of a solution, such as an abrasive solution, a polishing solution, water or another lubricant, to the tip of a drill bit and increasing a person's control over the drill bit. The hand held-water drilling system includes a drill bit coupled to a drill and to a solution delivery device. A shank of the drill bit is coupled to the drill, allowing the drill to supply torque to the shank to rotate the drill bit, and the shank of the drill bit is also coupled to a solution delivery device. In one embodiment, the shank of the drill bit is partially surrounding and rotates within a shank opening of the solution delivery device. The shank opening includes a solution delivery opening that receives solution, such as water, from a channel coupled to a solution source by a solution supply connector. In one embodiment, the solution delivery device includes a solution delivery control configured to prevent flow of solution from the channel to the solution delivery opening when in a first state and allow variable control flow of solution from the channel to the solution delivery opening. For example, the solution delivery control comprises a lever arm which enables solution flow from the channel to the solution delivery opening, where the solution is directed toward the drill bit, when depressed. The channel may be enclosed by a handle to allow movement of the drill bit to be controlled by applying pressure to one or more of a plurality of surfaces of the handle.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates a side view of an embodiment of a hand-held water drilling system.

FIGS. 2A and 2B illustrate side views of embodiments of a solution delivery device used in a hand-held water drilling system.

FIG. 2C illustrates a frontal view of an embodiment of a solution delivery device used in a hand-held water drilling system.

FIG. 2D illustrates a rear view of an embodiment of a solution delivery device used in a hand-held water drilling system.

FIG. 2E illustrates a cross-sectional view of one embodiment of a solution delivery device in a first state.

FIG. 2F illustrates a cross-sectional view of one embodiment of a solution delivery device in a second state.

FIG. 3A illustrates a side view of one embodiment of a drill bit adapter used by a hand-held water drilling system.

FIG. 3B. illustrates a side view of one embodiment of a drill bit adapter used by a hand-held water drilling system.

FIG. 3C illustrates a cross-sectional view of one embodiment of a drill bit adapter used by a hand-held water drilling system

FIG. 3D illustrates a side view of one embodiment of coupling a drill bit to a drill bit adapter used by a hand-held water drilling system.

FIG. 4A illustrates a side view of one embodiment of a drill bit adapter coupled to a solution delivery device.

FIG. 4B illustrates a side view of one embodiment of coupling a drill bit to a drill bit adapter that is coupled to a solution delivery device.

FIG. 4C illustrates a side view of one embodiment of a drill bit adapter coupled to a drill bit and to a solution delivery device.

FIG. 5 illustrates a side view of one embodiment of an extended-shank drill bit for coupling to a solution delivery device.

FIG. 6A illustrates one embodiment of coupling a solution supply line to a solution delivery device.

FIG. 6B illustrates one embodiment of a solution supply line.

FIG. 7A illustrates an example use of a hand-held water drilling system.

FIG. 7B illustrates an example use of a hand-held water drilling system using a portable pressure supply.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying Figures. It is noted that wherever practicable similar or like reference numbers may be used in the Figures and may indicate similar or like functionality. The Figures depict embodiments of the disclosed system (or method) for purposes of illustration only. One skilled in the art will readily recognize from the following description that alternative embodiments of the structures and methods illustrated herein may be employed without departing from the principles described herein.

### Hand-Held Water Drilling System

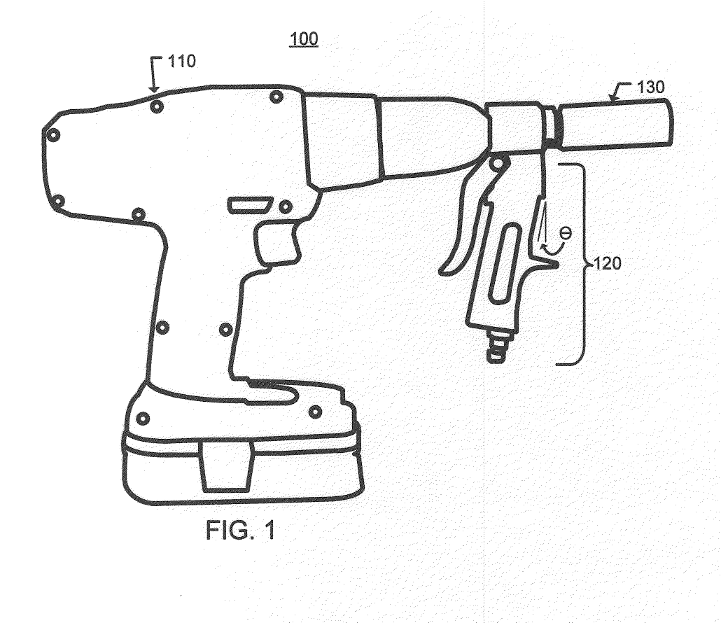

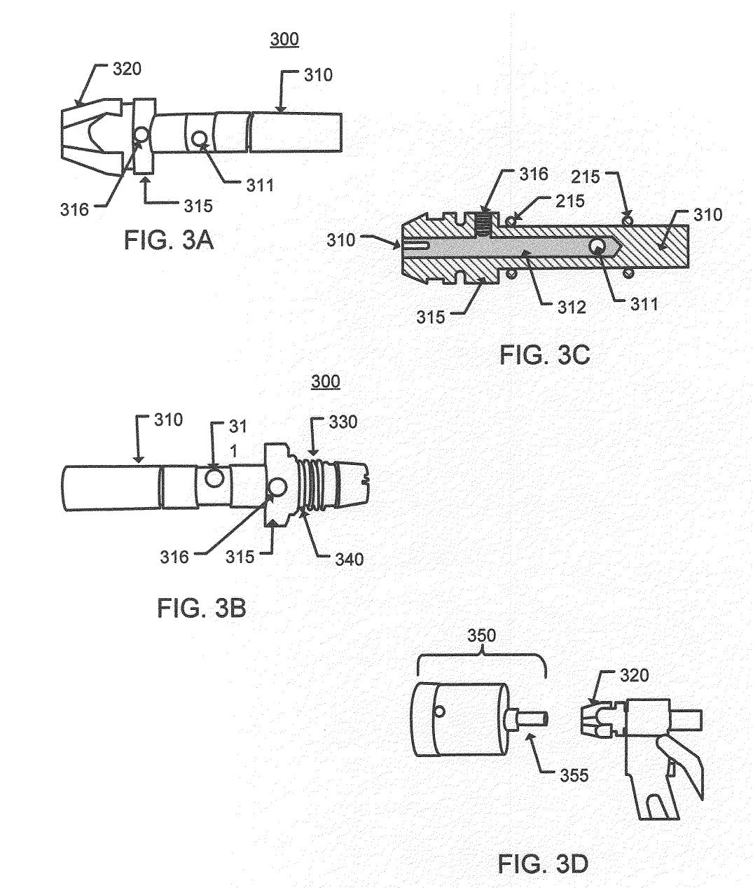

FIG. 1 illustrates a side view of an embodiments of a hand-held water drilling system 100 including a drill 110, a solution delivery device 120 and a drill bit 130. In this disclosure, the term drill bit 130 refers to rotatable tools designed to be operable in use with a portable drill. For example, this includes drill bits, core bits, grinders, sanders, brushes, polishing pads and other rotating tools. A first portion of a shank, such as a shank of a drill bit or a shank of a drill bit adapter, further described below in FIGS. 3A-3C, is coupled to an opening of the drill 110 and the shank 310 is also coupled to a solution delivery device 120. While FIG. 1 illustrates a cordless drill 110 operating from a portable power supply, such as a battery, in other embodiments, the drill 110 may be coupled to a battery or power supply via a cord.

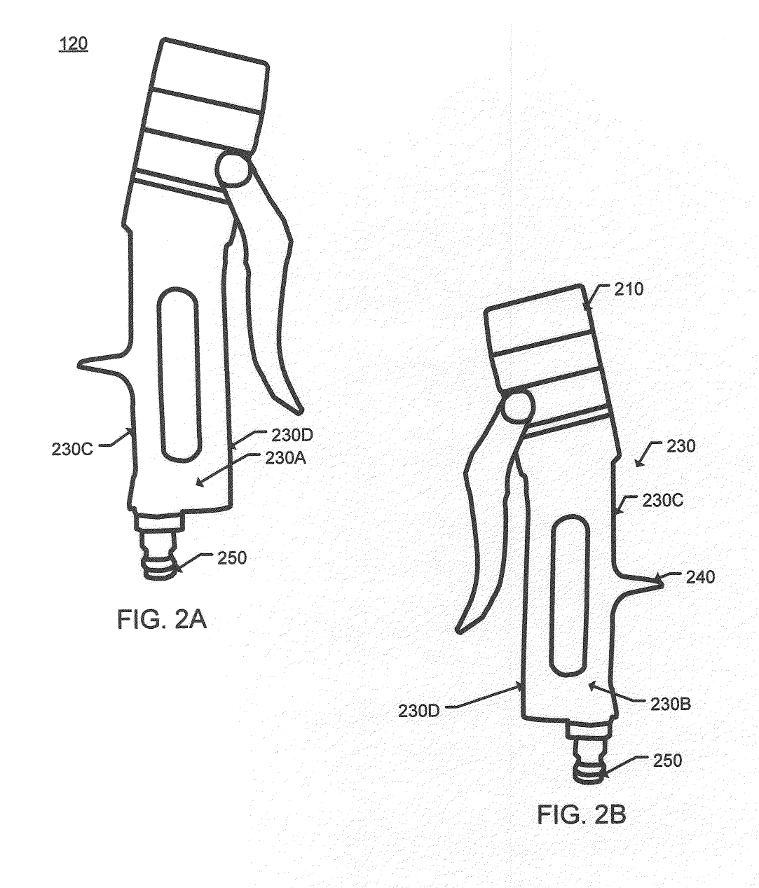

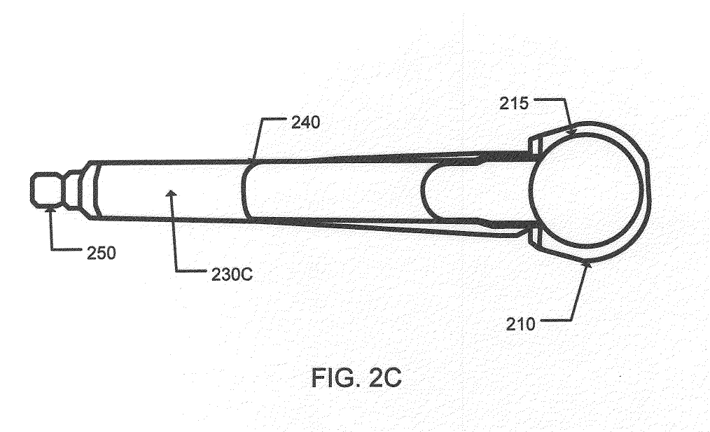

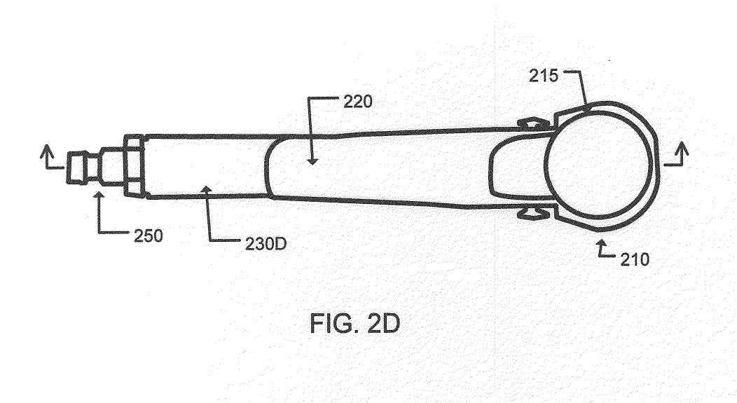

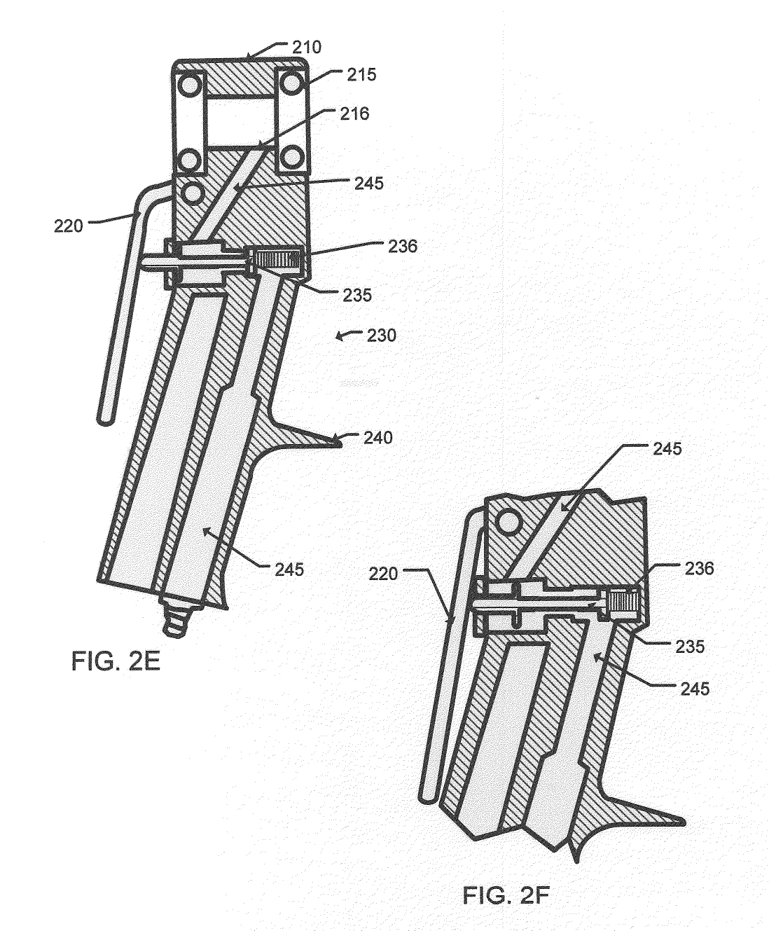

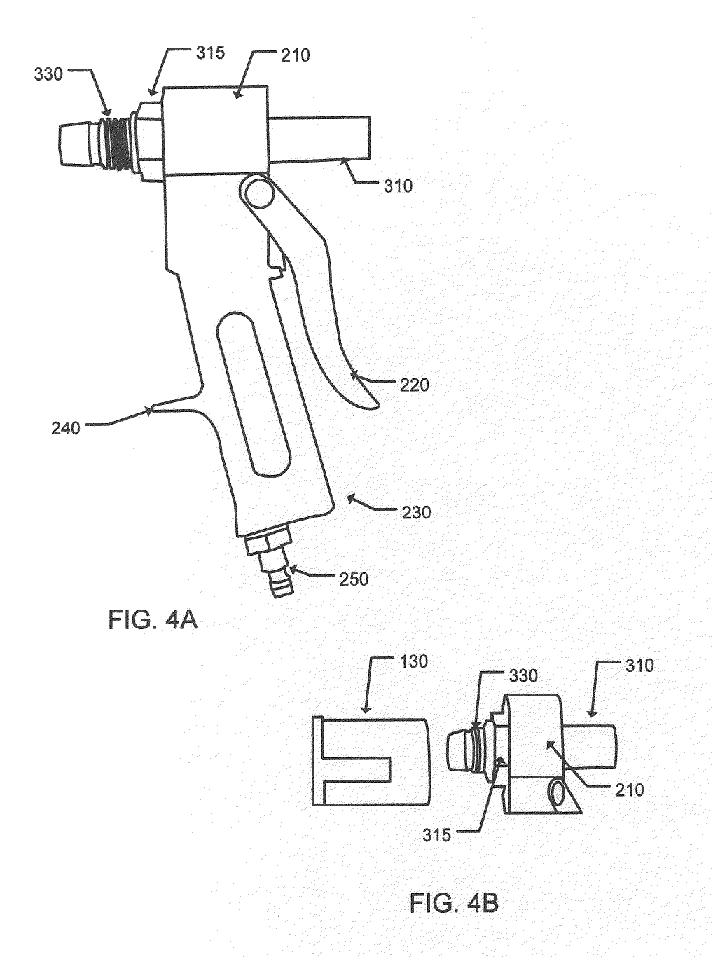

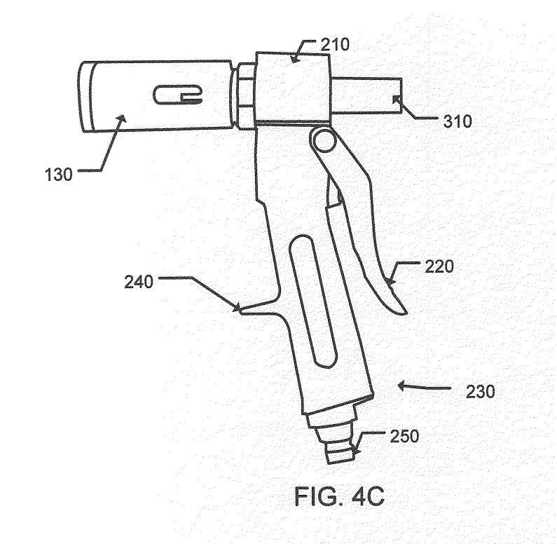

Thus, power from the drill 110 rotates the shank 310, which in turn rotates the drill bit 130, while the solution delivery device 120 directs solution, which may be a liquid such as water, detergent solution, oil or a slurry such as an abrasive solution or cutting solution from a solution source to the tip of the drill bit 130, as further described below in conjunction with FIGS. 2A, 2B and 4A-4C. In one embodiment, the solution delivery device 120 comprises a casted aluminum component including a solution delivery channel 245 including a valve 235, providing a lightweight and corrosion-resistant component for directing water, or another suitable solution, from a source to the tip of the drill bit 130 when necessary. Additionally, the solution delivery device 120 has sufficient length to allow a user to control the drill bit 130 by gripping and applying pressure to the solution delivery device 120. As shown in FIG. 1, the solution delivery device 120 is coupled to the shank 310 of the drill bit 130, or of a drill bit adapter 300, so the solution delivery device 120 is proximate to the drill bit 130, allowing use of the solution delivery device 120 as a handle 230 to provide increased control over the drill bit 130, reducing the likelihood of the drill bit 130 drifting across a surface.

In another embodiment, a first portion of a shank of a pad adapter is coupled to an opening of the drill 110 and the shank 310 is also coupled to a solution delivery device 120. Power from the drill 110 rotates the shank 310, which in turn rotates a pad coupled to a surface of the pad adapter. For example, the shank 310 is coupled to a first surface of the pad adapter while a second surface of the pad adapter that is parallel to the first surface includes hook and loop connectors. This allows a buffing pad to be removably attached to the second surface of the pad adapter using the hook and loop connectors. Thus, power from the drill is used to rotate the buffing pad, while the solution delivery device 120 directs solution, such as a polishing solution or another abrasive solution, from a solution source to the second surface of the pad adapter, allowing a pad attached to the second surface of the pad adapter to abrade a surface using the abrasive solution. In one embodiment, the solution delivery device 120 comprises a casted aluminum component including a solution delivery channel 245 including a valve 235, providing a lightweight and corrosion-resistant component for directing a polishing compound or another abrasive solution from a source to the second surface of the pad adapter when necessary. Additionally, the solution delivery device 120 has sufficient length to allow a user to control the pad by gripping and applying pressure to the solution delivery device 120. For example, a buffing pad may be attached to the pad adapter and the solution delivery device 120 directs an abrasive solution or a fluid polishing compound to the buffing pad, to allow the pad to polish stone or remove hard water stains from glass when power from the drill causes the pad to rotate.

### Example Solution Delivery Device Design

FIGS. 2A and 2B are side views of embodiments of a solution delivery device 120 used in a hand-held water drilling system 100, such as the system described above in conjunction with FIG. 1. FIGS. 2C and 2D also respectively depict a front view and a rear view of embodiments of a solution delivery device 120.

The solution delivery device 120 includes a shank opening 210, a solution delivery control 220, a handle 230 and a solution supply connector 250. The handle 230 which may have a plurality of surfaces 230A, 230B, 230C, 230D and a guide surface 240. In one embodiment, the shank opening 210, the plurality of surfaces 230A, 230B, 230C, 230D and the guide surface 240 are components included in a cast aluminum component. In another embodiment, the shank opening 210, the plurality of surfaces 230A, 230B, 230C, 230D and the guide surface 240 comprise various aluminum components that are coupled together. However, in other embodiments the shank opening 210, the plurality of surfaces 230A 230B, 230C, 230D and the guide surface 240 may be constructed from another suitable material, or from other suitable materials, such as one or more lightweight and corrosion-resistant materials.

The shank opening 210 is a circular orifice configured to allow a shank of a drill bit 130, or of a drill bit adapter 300, to pass through the shank opening 210, while allowing the shank or adapter or drill bit to rotate freely. In one embodiment, the shank opening 210 comprises a first circular opening and a second circular opening in a plane parallel to a plane including the first circular opening, with aluminum or another suitable material coupling the circumference of the first circular opening to the circumference of the second circular opening. In one embodiment, the shank opening 210 include one or more seals 215 through which a shank passes. For example, the shank opening 210 comprises a first opening including a first seal 215 and a second opening including a second seal 215, where the second opening is in a plane parallel to a plane including the first opening. The seals 215 cooperate to maintain the solution within the interior of the shank opening 210 while the shank rotates, the solution is directed from the channel 245 to the shank inlet 311.

The shank opening 210 is coupled to a handle comprising a first surface 230A coupled to a second surface 230B that is parallel to the first surface 230A. As shown in FIG. 2C, a third surface 230C oriented in a direction perpendicular to the first surface 230A and the second surface 230B couples the first surface 230A to the second surface 230B. Similarly, FIG. 2D shows a fourth surface 230D, also oriented in a direction perpendicular to the first surface 230A and the second surface 230B, coupling the first surface 230A to the second surface 230B. In one embodiment, the first, second, third and fourth surfaces 230A, 230B, 230C, 230D enclose a channel directing solution receive via the solution supply connector 250, such as a male quick connector coupling or another connector suitable for connection to a solution supply, to a solution delivery opening 216 included in an interior surface the shank opening 210, to supply solution to the shank opening 210 as shown in FIG. 2E. In one embodiment, the solution delivery opening 216 is included in an interior surface of the aluminum or another suitable material coupling the circumference of the first circular opening to the circumference of the second circular opening. Hence, the channel allows solution to be received from a solution supply, or solution source, via the solution supply connector 250, through the base of the handle 230 and directed toward a drill bit tip, or toward a surface proximate to the drill bit tip, through the solution delivery opening 216. Delivery of the solution flow may be regulated through channel 245 through valve 235. In one embodiment, the first, second, third and fourth surfaces 230A, 230B, 230C, 230D comprise surfaces of a cast aluminum component. Alternatively, the first, second, third and fourth surfaces 230A, 230B, 230C, 230D are aluminum components coupled together. In various additional embodiments, the surfaces 230A, 230B, 230C, 230D may comprise one or more alternative materials.

As shown in FIGS. 2A and 2B, the handle formed by the first, second, third and fourth surfaces 230A, 230B, 230C, 230D is angled so that the shank opening 210 is not parallel to the fourth surface 230D. This angle is further illustrated with reference to FIG. 1A, which identifies an angle θ between the third surface 230C of the handle and a plane intersecting the first opening of the shank opening 210. The angle θ is an acute angle, preferably in the range of 0 to 30 degrees, with a recommended angle θ of 10 degrees. The angle θ allows for greater separation between the third surface 230C of the handle and the drill bit 130 and/or the surface being drilled. This allows use of the solution delivery device 120 to control the drill bit 130 while reducing the likelihood of a user's hand or fingers contacting the drill bit 130 or surface being drilled.

A solution delivery control 220 is coupled to one or more surfaces 230A, 230B, 230C, 230D of the solution delivery device 120 as shown in FIGS. 2A and 2D and is configured to regulate the flow or solution, such as water, lubricant or abrasive solution, from the channel to the solution delivery opening 216 in the shank opening 210. In the embodiment shown by FIGS. 2A-2F, the solution delivery control 220 comprises a lever arm where a first portion of a first lever arm surface is coupled to the first surface 230A and a second portion of a second lever arm surface is coupled to the second surface 230B so that a lever arm is substantially parallel to the fourth surface 230D when no pressure is applied to the lever arm in a first state as shown in FIG. 2E and the lever arm contacts the fourth surface 230D when pressure is applied to the lever arm to achieve a second state as shown in FIG. 2F

To regulate solution flow, the solution delivery control 220 is coupled to a valve 235 included in the channel. When the solution delivery control 220 is in a first state, the valve 235 blocks the flow of solution through the channel 245 to the solution delivery opening 216 and when the solution delivery control 220 is in a second state, the valve 235 allows solution to flow through the channel and to the solution delivery opening 216 included in the shank opening 210. For example, the valve 235 may include a spring 236 to bias and hold the valve 235 in a first state. When pressure is applied to the lever arm, the lever arm contacts a valve control causing the valve gradually open allowing solution to begin to flow to flow through channel 245 to the solution delivery opening 216. When pressure is further applied the valve 235 eventually reaches a second state as the spring 236 is further compressed until the valve 235 reaches a second state of maximum solution flow. Releasing the lever arm causes the spring 236 to rebound and the valve 235 to return to its closed position and block solution from flowing through the channel 245 to the solution delivery opening 216. At positions between the first state and the second state, the solution flow rate may be controlled at intermediate flow rates less than the maximum. When desired, the solution flow rate may be modulated from a first state to a second state at a high frequency with intervals of less than one second. While FIGS. 2A and 2B depict an embodiment where the solution delivery control 220 is a lever arm, in other embodiments the solution delivery control 220 may comprise another suitable device for opening or closing a valve, such as a button, a knob, a shaft or any other suitable switching device.

In one embodiment, the solution delivery device 120 also includes a guide surface 240 that is perpendicular to the fourth surface 230D and coupled to the fourth surface 230D. The guide surface 240 provides a surface on which a user's fingers may rest while gripping the handle, facilitating extended use of the hand-held water drilling system 100 by making it easier for grip the solution delivery system 120. Having a handle 230 located distally from the drill 110 allows the user to maintain maximum control and stability of the drill bit 130 simultaneously while regulating and varying solution delivery.

### Example Drill Bit Adapter

FIGS. 3A and 3B illustrate side views of one embodiment of a drill bit adapter 300 used by a hand-held water drilling system. FIG. 3C shows a cross-sectional view of one embodiment of a drill bit adapter 300 used by a hand held solution delivery system. The drill bit adapter 300 includes a shank 310 and a spacer 315 coupled to a first portion of the shank 310. In one embodiment, the spacer 315 has a circular cross-section and has a diameter larger than the diameter of the shank 310 and separates a threaded region 330 from the shank 310. It is not necessary that the spacer 315 have a circular cross-section. However, it is preferable that at least one cross-sectional dimension be larger than the inner diameter of the seal 215.

As shown in FIGS. 4A-4C, when the drill bit adapter 300 is coupled to the solution delivery device 120, a surface of the spacer 315 contacts a first opening of the shank opening 210 to produce a separation between the threaded region 330 and the first opening of the shank opening 210. As the threaded region 330 is used to couple a drill bit 130 to the drill bit adapter 300, as further described below in conjunction with FIGS. 3D and 4A-4C, the spacer 315 limits shank 310 insertion depth and prevents the drill bit 130 from rubbing against the shank opening 210. In one embodiment, a washer 340, comprising a material softer than the drill bit 130 and the spacer 315, contacts a surface of the spacer 315 proximate to the threaded region 330 to further prevent rubbing of a surface of the drill bit 130 against the shank opening 210. As such as the solution delivery device 120 surrounds at least a portion of the shank 310.

As shown in FIG. 3C the shank 310 may have an interior surface and an external surface. The interior surface forms an internal cavity 312 having an shank inlet 312 and a shank outlet 313. On the external surface, the shank inlet 312 is located on the perimeter of the shank to receive solution from within the shank opening 210. The shank outlet 313 is located on the longitudinal axis of the shank 310 external surface. Thus fluid communication for the solution is maintained between the channel 245 and the drill bit 130.

The threaded region 330 of the drill bit adapter 300 is a threaded male connector that is inserted into a corresponding threaded female connector of a drill bit 130 to couple the drill bit 130 to the drill bit adapter 300. A bit adapter nut 320 may be used to allow the threaded region 330 to be used as a connector region for receiving a drill bit 130 shank, allowing use of the drill bit adapter 300 with a wider range of drill bits 130. This allows the drill bit adapter 300 to enable use of the solution delivery device 120 by a variety of conventionally-designed drill bits 130. Since the shank 310 is freely rotatable within the shank opening 210, to assist tightening of the drill adapter nut 320 during assembly, the spacer 315 may be provided with a tool indent 316. The tool indent 316 provides a location to place a tightening tool such as an allen wrench when installing a drill bit 130. The tool indent 316 may be constructed by installing a hex style set screw within a threaded passage positioned radially between the perimeter and the interior of the spacer 315. The set screw can then be used to temporarily place the tightening tool to prevent shaft rotation while tightening bit adapter nut 320. FIG. 3D illustrates use of the bit adapter nut 320 to couple a conventional arbor bit 350 to the drill bit adapter 300. The threaded region 330 is inserted into a threaded female connector in the bit adapter nut 320 and a male connector 355 of the arbor bit 350 is inserted into an opening in the bit adapter nut 320 to create an arbor to couple the arbor bit 350 to the bit adapter 300. While FIG. 3D shows coupling of an arbor bit 350 to the bit adapter nut 320, in other embodiments, various types of drill bits and other compatible rotating tools may be coupled to the bit adapter 300 using the bit adapter nut 320.

FIGS. 4A-4C show an example coupling of a drill bit 130 and drill bit adapter 300 to a solution delivery device 120. FIG. 4A shows the drill bit adapter 300 coupled to the shank opening 210 of the solution delivery device 120. As shown in FIG. 4A, the shank 310 is inserted through the shank opening 210 and a first surface of the spacer 315 contacts the first opening of the shank opening 210. FIG. 4B shows that the threaded region 330 of the drill bit adapter 300 is inserted into a female threaded connector of the drill bit 130 to couple the drill bit 130 to the shank 310. To facilitate solution transfer from the solution source to the distal tip of the arbor bit 350, male connector 355 is preferable of a hollow core design with an opening positioned longitudinally along a center line to the drill bit male connector 355. FIG. 4C shows the drill bit 130 coupled to the threaded region 330 of the drill bit adapter 300 and the shank 310 of the drill bit adapter 300 coupled to the shank opening 210, allowing the solution delivery device 120 to provide water, lubricant, other solution or slurry, to the drill bit 130 through the drill bit adapter 300.

Use of Solution Delivery Device with Drill Bit

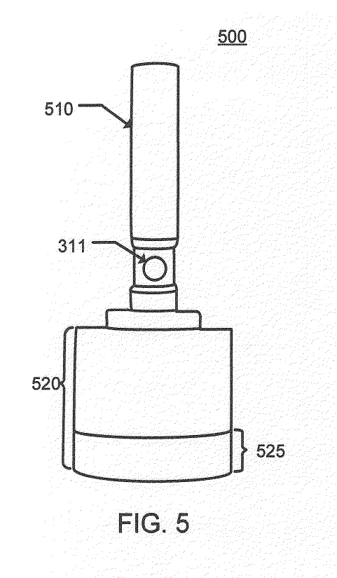

In addition to using a drill bit adapter 300 to couple various drill bits 130 to the solution delivery device 120, drill bits having an extended shank may also be used directly with the solution delivery device 120 without the drill bit adapter 300. FIG. 5 shows one embodiment of an extended-shank drill bit 500 for use in conjunction with the solution delivery device 120. The example extended-shank drill bit 500 shown in FIG. 5 comprises a shank coupled to a bell 520. In one embodiment, a surface of the bell 520 includes diamonds embedded in a portion of the bell 520, forming a diamond matrix 525 that allows the extended-shank drill bit 500 to cut through a variety of surfaces, such as ceramic, porcelain and/or glass. The shank 510 of the extended-shank drill bit 500 is longer than the shank of conventional drill bits, such as the arbor bit 350 shown in FIG. 3D, allowing the extended-shank drill bit 500 to be directly coupled to the shank opening 210 of the solution delivery device 120 without using a drill bit adapter 300. In one embodiment, the shank of the extended-shank drill bit 500 may include a the spacer 315, such as the spacer described above in conjunction with FIG. 3. The spacer 315 has a circular cross-section and has a diameter larger than the diameter of the extended-shank separates the bell 520 from the extended shank 310. This allows the spacer 315 to prevent the bell 520 from contacting the shank opening 210. Thus, the solution delivery device 120 may be used with customized drill bits and also with conventional drill bits by using the bit adapter 300 described above in conjunction with FIGS. 3A-4C.

### Example Solution Supply Line

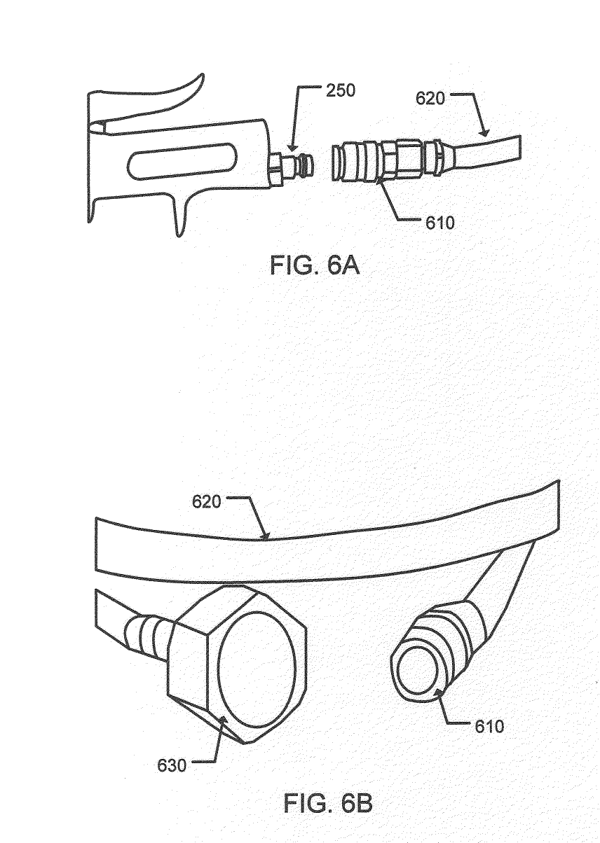

FIG. 6A illustrates one embodiment of coupling of a solution supply line 630 to a solution delivery device 120, while FIG. 6B depicts examples of connectors used by a solution supply line 620. In the embodiment shown by FIG. 6A, the solution supply connector 250 at the base of handle 230 to the solution delivery device 120 is a male quick connect connector that is inserted into a female quick connect connector 610 of the solution supply line 620 to couple the solution delivery device 120 to the solution supply line 620. After coupling, the solution supply line 620 directs solution, such as water, from a source into a channel in the solution delivery device 120 through the solution supply connector 250.

As shown in FIG. 6B, the solution supply line 620 may include different types of connectors to allow coupling of the solution supply line 620 to various types of solution sources. For example, the solution supply line 620 may include a threaded connector 630 for coupling the solution supply line 620 to a solution source, such as a spigot or faucet, having a threaded connector. In one embodiment, the threaded connector 630 may also allow the solution supply line to be coupled to a pressurized solution container, allowing a portable solution supply to be coupled to the solution delivery device 120, increasing portability of the hand-held water drilling system 110. However, in other embodiments, the solution supply line 620 may use any suitable connector for coupling to a solution source 620 or to the solution delivery device 120.

### Example Use of Solution Delivery Device

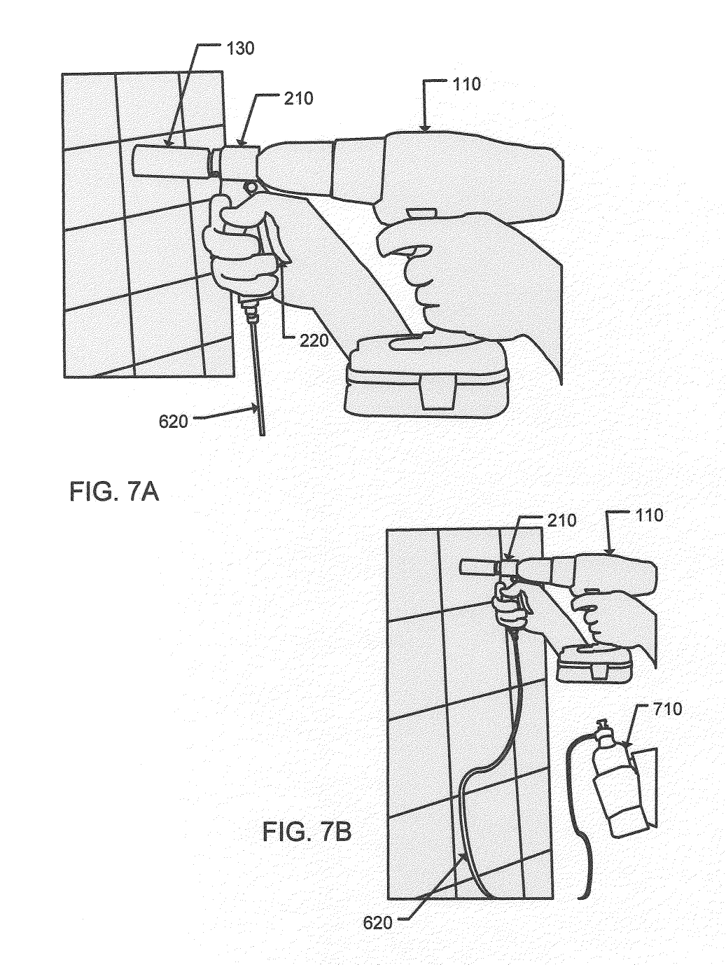

FIGS. 7A and 7B illustrate example uses of a hand-held water drilling system 100 for drilling a tile surface. However, in other embodiments, the hand-held water drilling system 100 may be used to drill marble, glass, granite, porcelain or other hard surfaces. As shown in the example of FIG. 7A, a user's first hand operates the drill 110 to supply torque to the drill bit 120 and a user's second hand operates the solution delivery control 220 to direct water, or another solution, from the solution supply line 620 through the shank opening 210 of the solution delivery device 120 to lubricate the tip of the drill bit 130. For example, applying pressure to the solution delivery control 220 opens a valve in the solution delivery device 120 causing water, or other solution, to flow into the shank opening 210 where the water, or other solution, is directed to the tip of the drill bit 130 or to the surface being drilled. As shown in FIG. 7A, because the solution delivery device 120 is between the drill 110 and the tip of the drill bit 130, the user's second hand may be used to more precisely control the pressure and orientation of the drill bit 130 simultaneously while controlling and varying the supply of water, or other solution to cool the tip of the drill bit 130.

FIG. 7B shows an embodiment where the hand-held water drilling system 100 is used with a portable pressurized solution supply 710, such as a canister or other container including pressurized water or other solution. As shown in FIG. 7B, the portable pressurized solution supply 710 may have compact dimensions to facilitate its movement to different locations by a user. In the embodiment shown by FIG. 7B, the portable pressurized solution supply 710 is coupled to the solution supply connector 250 of the solution delivery device 120 using a solution supply line 620. As described above in conjunction with FIG. 7A, manipulation of the solution delivery supply control 220 allows water, or other solution, to flow from the portable pressurized solution supply 710 through the solution supply line 620 and the solution delivery device 120 to the tip of the drill bit 130 via the shank opening 210. For example, if the solution delivery control 220 comprises a lever arm, application of pressure to the lever arm activates a valve 235 which enables solution to flow from the portable pressurized solution supply 710 through the solution supply line 620 and the channel 245 of the solution delivery device 120 to the drill bit 130 through the shank opening 210.

Upon reading this disclosure, those of skill in the art will appreciate still additional alternative structural and functional designs for a system and a process for providing a hand-held water drilling system through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A hand-held drilling system comprising:
a drill coupled to a shank of a drill bit, the drill configured to apply torque to the shank to rotate the drill bit;
a solution delivery device surrounding at least a portion of the shank of the drill bit and having a handle coupled to a solution source;
the solution delivery device having a solution delivery control configured to block solution flow from the solution source through a channel within the handle and toward the drill bit when in a first state and configured to allow solution flow from the solution source when in a second state.

2. The hand-held drilling system of claim 1, wherein the solution source is a portable pressure solution supply.

3. The hand-held drilling system of claim 1, wherein the shank includes a threaded region for attaching a drill bit.

4. A solution delivery device comprising:
a shank opening wherein a circumference of a first circular opening is coupled to a circumference of a second circular opening, the second circular opening in a plane parallel to a plane including the first circular opening and the shank opening having an exterior surface and an interior surface, the interior surface including a solution delivery opening;
a first seal located within the first circular opening and a second seal located within the second circular opening;
a handle coupled to the shank opening, the handle forming an acute angle relative to the shank opening plane;
a channel within the handle in fluid communication with the solution delivery opening;
the channel having a valve located within the handle; and
a solution delivery control in communication with the valve to control solution delivery flow rate.

5. The solution delivery device of claim 4, wherein the solution delivery control is a lever arm configured to activate the valve to block the flow of solution in the channel in a first state and to allow flow of the solution in a second state.

6. The solution delivery device of claim 5, wherein the lever arm can be used to regulate solution flow between a first state and a second state.

7. The solution delivery device of claim 5, wherein the lever arm is substantially parallel to at least one surface of the handle.

8. The solution delivery device of claim 4, wherein the acute angle is approximately 10 degrees.

9. The solution delivery device of claim 4, wherein the handle includes a guide surface.

10. The solution delivery device of claim 4 having a spacer with a tool indent.

11. The solution delivery device of claim 4 having a arbor for receiving a conventional shaft drill bit.

12. The solution delivery device of claim 4 having a drill bit adapter having a threaded region for receiving a drill bit.

13. An extended shank drill bit configured for use in a solution delivery device comprising:
a shank having an exterior surface and a shank cavity;
the exterior surface having a spacer with at least on cross-sectional dimension greater than the diameter of the shank;
the shank cavity having a shank outlet located on the circumference perimeter of the exterior surface; and
the shank cavity also having a shank outlet located along the longitudinal axis of the shank.

14. The extended shank drill bit of claim 13 also having a bell at the distal end of the shank.

15. The extended shank drill bit of claim 14 also having a diamond matrix 525 attached to the bell 520.
